(19) United States
(12) Patent Application Publication
(10) Pub. No.: US 2018/0153103 A1
(43) Pub. Date: Jun. 7, 2018

(54) MACHINE FOR AUTOMATICALLY HARVESTING FRUITS CULTIVATED IN ROWS

(71) Applicant: AGROBOT INC., Wilmington, DE (US)

(72) Inventor: Juan BRAVO TRINIDAD, Wilmington, DE (US)

(21) Appl. No.: 15/366,091

(22) Filed: Dec. 1, 2016

(51) Int. Cl. A01D 46/30; A01D 69/02; A01D 34/01

(52) U.S. Cl. CPC A01D 46/30; A01D 2101/00; A01D 34/01; A01D 69/02

(57) ABSTRACT

Machine (1) for the automatic harvesting of fruits cultivated in rows, formed by a self-propelled and autonomous vehicle encompassing at least one crop row (13), including a pair of parallel rails (2), a fruit collector assembly formed by a carriage (3) movably mounted on the pair of parallel rails (2) and a collector robotic arm (4) movably mounted on the carriage (3) for moving transversely with respect to the carriage (3), a carriage motor (5) for moving the carriage (3), and a robotic arm motor (6) for moving the robotic arm (4), the carriage and the robotic arm motors (5, 6) attached to the carriage (3). The carriage is movable horizontally and the robotic arm is transversally movable with respect to the rails.

### OBJECT OF THE INVENTION

The invention refers in general to machines for automatically harvesting fruits cultivated in rows. The invention is preferably applicable for harvesting strawberries.

An object of the invention is to provide an automatic harvesting machine with improved harvesting capacity, which is compact and easy to transport and to maintain.

### FIELD OF APPLICATION

The invention refers in general to the agricultural industry, and more particularly to the manufacture of agricultural machinery and equipment, specially robotized systems for harvesting.

### BACKGROUND OF THE INVENTION

Various crops, such as strawberries, have been typically harvested using manual labor due to the delicate nature of the crops and the selective nature of the harvesting. The high seasonal demand for laborers and the limited labor force have resulted in a significant increase of labor costs.

As a result, numerous mechanical harvesters have been developed to reduce the labor and lower the overall cost of the harvested fruit. Most of the mechanical harvesters are extremely complex in operation and have a large number of moving parts that makes them difficult and costly to manufacture and maintain.

Some prior art machines are based on robotic arms controlled by a vision system for detecting and harvesting fruits. For example, U.S. Patent application U.S. 2011/252760 A1 is an example of a scalable machine for automatically harvesting fruits, wherein a robotic arm is controlled by a viewing system, and contact and distance sensors provide delicate handling of the harvested fruit.

Chinese patent application CN102577747A discloses an overhead strawberry picking robot, which comprises a collecting assembly formed by a carriage movable about a horizontal axis, and a shaft movable about a vertical axis. A robotic arm performs 3D movements and it is coupled at one end of the vertical shaft. As it can be observed for example in FIG. 1 of this Chinese patent application, typically there are two motors associated to respective endless screws, and the motors are separated from each other at separated locations of the machine.

One drawback of these traditional harvesting robots, is that its robotic arm is driven by long endless screws coupled with the shaft of an electric motor, so that it is necessary to provide enough space to accommodate the endless screws and motors, which results in large and bulky machines. Additionally, a large room has to be provided for allowing the 3D movement of the robotic arm, thus the machine requires a large space of operation, and its harvesting capacity is limited. Furthermore, the robotic arm has to be operated slowly to avoid striking and damaging crops accidentally.

Therefore, there is the need in this industrial field for harvesting robots with improved harvesting capacity, and which are simple to manufacture and repair.

### DESCRIPTION OF THE INVENTION

The invention refers to an automatic machine for harvesting fruits cultivated in rows, which is preferably embodied as a self-propelled vehicle configured to autonomously move along a field of crop rows.

The harvesting automatic machine comprises at least a pair of straight rails parallel to each other, which when the machine is in use, are placed within a plane orthogonal to the ground.

At least a fruit collector assembly, preferably two or more of them, are coupled with the pair of rails and it can move along the rails. Each fruit collector assembly comprises a sliding carriage mounted on the pair of parallel rails, so that the carriage is movable along the pair of parallel rails reciprocally in both directions.

In turn, a collector robotic arm is mounted on the carriage, in such a manner that the robotic arm is movable with respect to the carriage in a transverse direction to the parallel rails. The robotic arm has a cutting and collecting head attached at its lower end for cutting and collecting fruits.

A first motor is provided for moving the carriage, and a second motor is provided for moving the robotic arm. A conventional rack and pinion mechanism is preferably used for the movement of the carriage and for the movement of the robotic arm.

The machine of the invention is characterized in that the first and second motors are mounted on the carriage. Due to this arrangement of the motors placed together at the carriage, the fruit collector assembly is very compact, which in turn allows two or more of these assemblies to be mounted on the same pair of parallel rails.

Two or more pairs of parallel rails are arranged consecutively one after the other in parallel planes, so that a machine with high density of fruit collector assemblies per area is obtained, and the harvesting capacity (speed) of the machine is improved with respect to prior art machines.

Unlike prior art endless screws based machines, in present invention the fruit collector assembly is self-propelled, which results in a compact and simplified design.

Preferably, the first and second motors are electric motors and the pair of parallel rails are connected to an electric power source, so that the two motors are fed through the rails. This feature has the advantage that no wiring is used to feed the motors, hence the machine construction and maintenance is additionally simplified.

On operation, each robotic arm operates autonomously and independently from the rest for collecting the fruits, as the machine moves along the crop rows. These robotic arms are oriented towards one side of each row.

Conventionally, the machine comprises a viewing system including cameras and image processor, for detecting fruits positions, for example based on the fruits color and/or shape. Additionally, a controller is provided in cooperation with the viewing system, to coordinate individually the movements of the fruit collector assemblies mounted on the same pair of rails to avoid collisions, and for guiding each robotic arm towards each piece of fruit.

Some of the advantages of the inventions are the followings:
high density of robotic arms per area
high processing speed
robotic arms easily replaceable
low manufacturing and maintenance cost
wireless construction
water and dust resistant

### DESCRIPTION OF THE DRAWINGS

To complement the description which is being made and for the purpose of aiding to better understand the features of the invention, a set of drawings is attached to the present specification as an integral part thereof, in which the following has been depicted with an illustrative and non-limiting character:

FIG. 1. shows in perspective view a detail of a fruit collector assembly mounted on a pair of parallel rails, according to a preferred embodiment of the invention.

FIG. 2. shows a front elevational view of the fruit collector assembly of FIG. 1.

FIG. 3. shows another perspective view of the assembly of FIG. 1.

FIG. 4. shows a rear elevational view of the assembly of FIG. 1.

FIG. 5. shows a perspective view of a cutting and collecting head, according to a preferred embodiment of the invention.

FIG. 6. shows a front elevational view of an embodiment of the harvesting machine in use, that is, suitably placed at a field of crops arranged in rows.

FIG. 7. shows a front elevational view of an embodiment of the harvesting machine, wherein the machine is in a folded position for transportation and storage.

FIG. 8. shows a plan view of an embodiment of the harvesting machine, without the vehicle.

FIG. 9. shows a side elevational view of the machine of FIG. 8.

### PREFERRED EMBODIMENT OF THE INVENTION

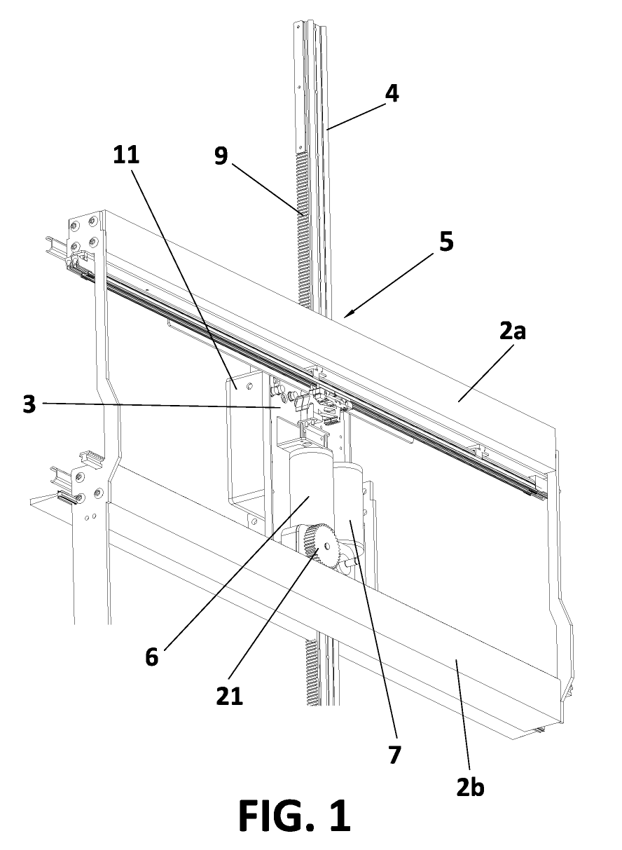

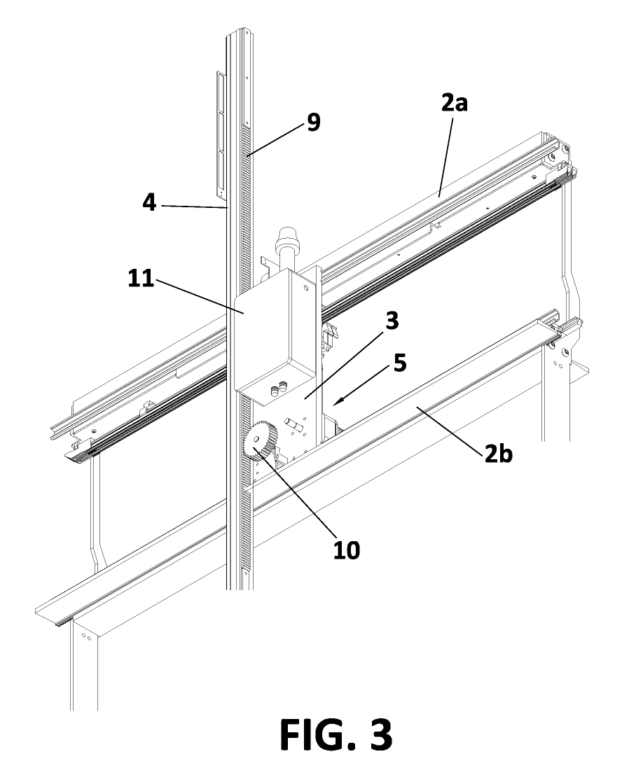

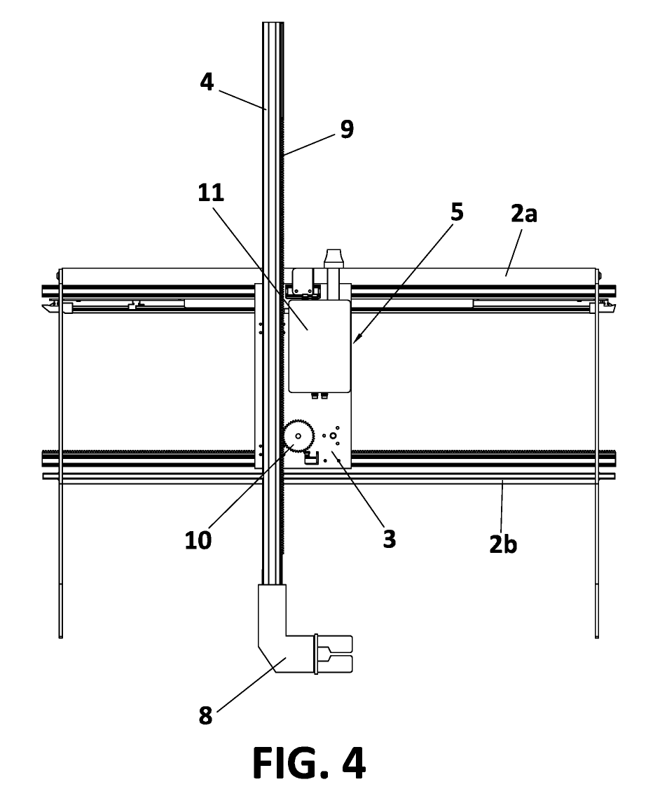

FIGS. 1 to 5 show in detail a fruit collector assembly (5) mounted at a pair (2) of rails (2a, 2b) which are parallel to each other, and that when the machine is in use the pair of rails (2a, 2b) are lying within a plane orthogonal to ground. The fruit collector assembly (5) is displaceable along the parallel rails (2a, 2b), and for that the fruit collector assembly (5) includes a carriage (3) movably mounted on the pair of parallel rails (2a, 2b), and a collector robotic arm (4) movably mounted on the carriage (3). The carriage (3) is movable along the pair of parallel rails (2a, 2b), and the robotic arm (4) is movable in a transverse direction to the parallel rails (2a, 2b), that is, vertically with respect to the ground.

First and second electric motors (6, 7) are provided for moving respectively the carriage (3) and the robotic arm (4), and wherein the first and second motors (6, 7) are mounted on the carriage (3), in order to obtain a compact design that would allow several fruit collector assemblies (5) to be mounted in the same pair of rails (2a, 2b).

Preferably as shown in the figures, first and second motors (6, 7) are arranged parallel to each other (the motor shafts are parallel to each other), and preferably first and second motors (6, 7) are placed on the same side of the carriage (3), whereas the robotic arm is placed at the opposite side of the carriage (3).

A conventional rack and pinion mechanism, is preferably used to obtain the movement of the carriage and for the movement of the robotic arm. For this, there is a first toothed rack (not shown) at the lower rail (2b) and a first pinion (21) (toothed wheel) mechanically coupled by means of a reductor (not shown) with the first motor (6) shaft. The first pinion (21) is engaged with the first rack, so that when the first pinion (21) rotates, the carriage (3) moves along the rails (2a, 2b).

When several fruit collector assemblies (5) are mounted in the same pair of rails (2a, 2b), the toothed rack is common for all of them, and each assembly has its pinion engaged with the rack.

Similarly, there is a second toothed rack (9) at the robotic arm (4) and a second pinion (10) (toothed wheel) mechanically coupled by means of a reductor (not shown) with the second motor (7) shaft. The second pinion (10) is engaged with the second rack (9), so that when the second pinion (9) rotates, the robotic arm (4) moves vertically with respect to the carriage (3) and transversally to the rails (2a, 2b).

As it can be observed in the figures, in this embodiment first and second pinions (21, 10) are placed at opposite sides of the carriage (3).

For electrically feeding the motors (6, 7), the two rails (2a, 2b) are electrically powered. For example, the rails (2a, 2b) include electric conductors (not shown) extending along the rails (2a, 2b), and the two poles of an electric power source (not shown), preferably a DC power source, are respectively connected with the two conductors. The motors (6, 7) of each assembly (5) are electrically connected to the rails (2a, 2b) through the carriage (3) so that they are electrically fed continuously while they are moving.

A waterproof box (11) is also mounted on the carriage (3) for housing electric and electronic components, needed for controlling the fruit collector assembly (5).

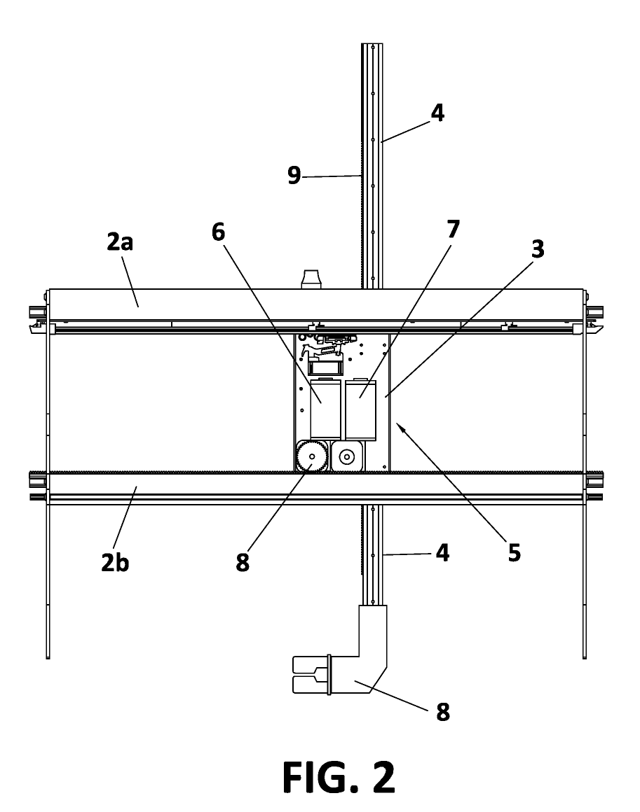

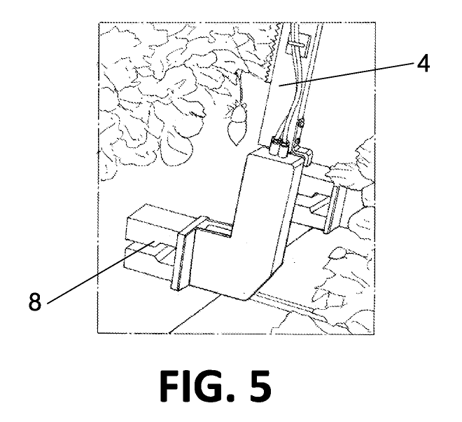

As shown in FIG. 2, the robotic arm (4) has a cutting and collecting head (8) attached at its lower end for cutting and collecting fruits. This head (8) is represented in more detail in FIG. 5, which includes a cutter (not shown) for cutting the fruits and a receptacle in the form of a basket for collecting the fruits.

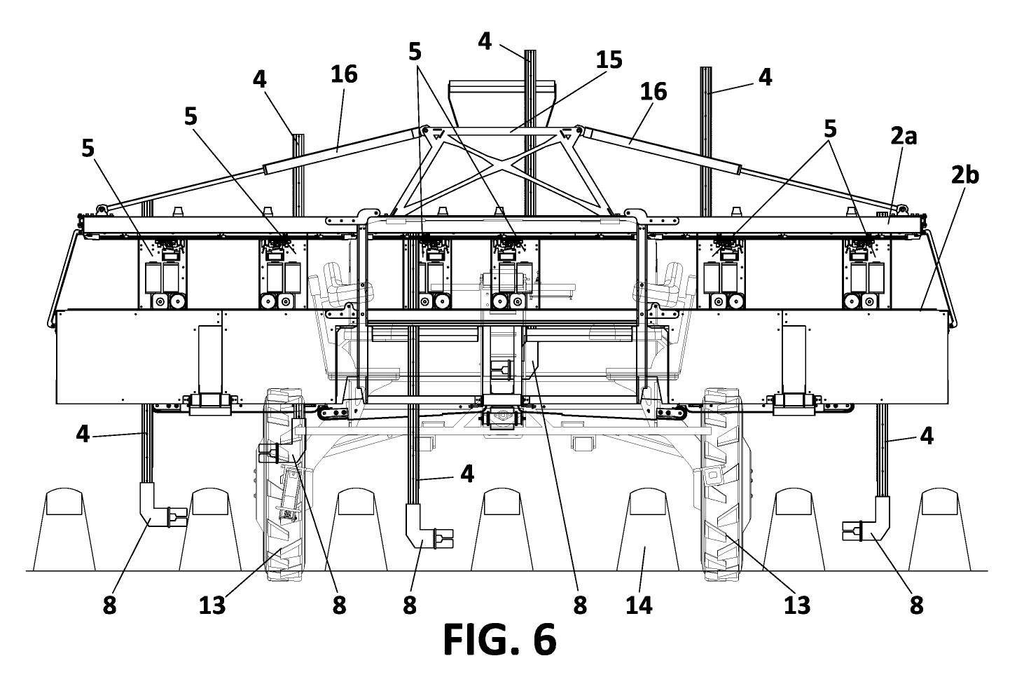

FIG. 6 shows a general view of a harvesting automatic machine (1) according to an exemplary embodiment of the invention, wherein several fruit cutting and collecting assemblies (5) are mounted at the same pair of parallel rails (2a, 2b). Since several fruit collector assemblies (5) share the same pair of rails (2), the number of components of the machine is reduced.

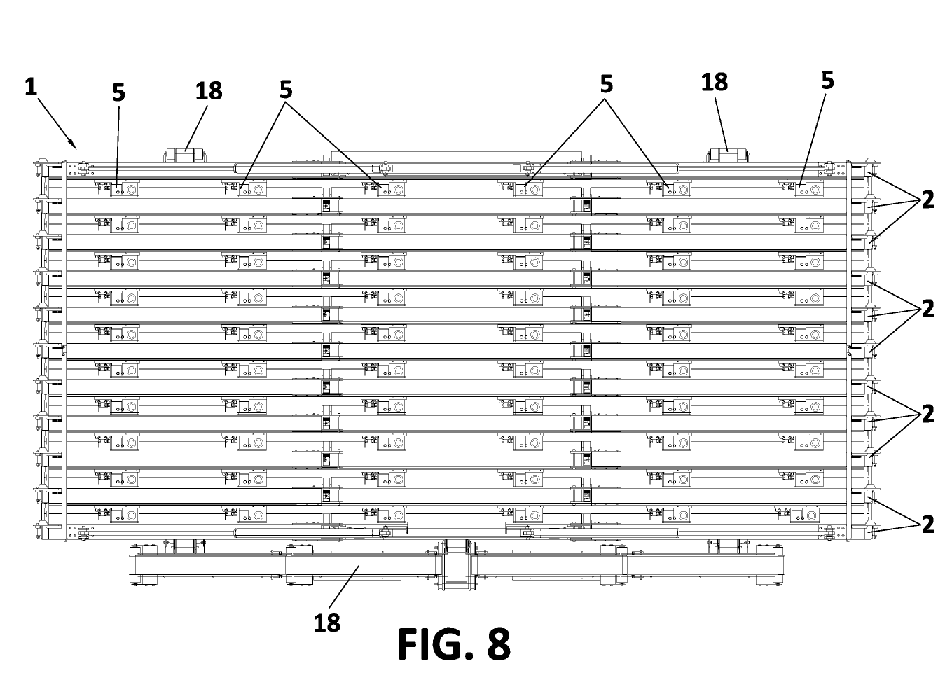

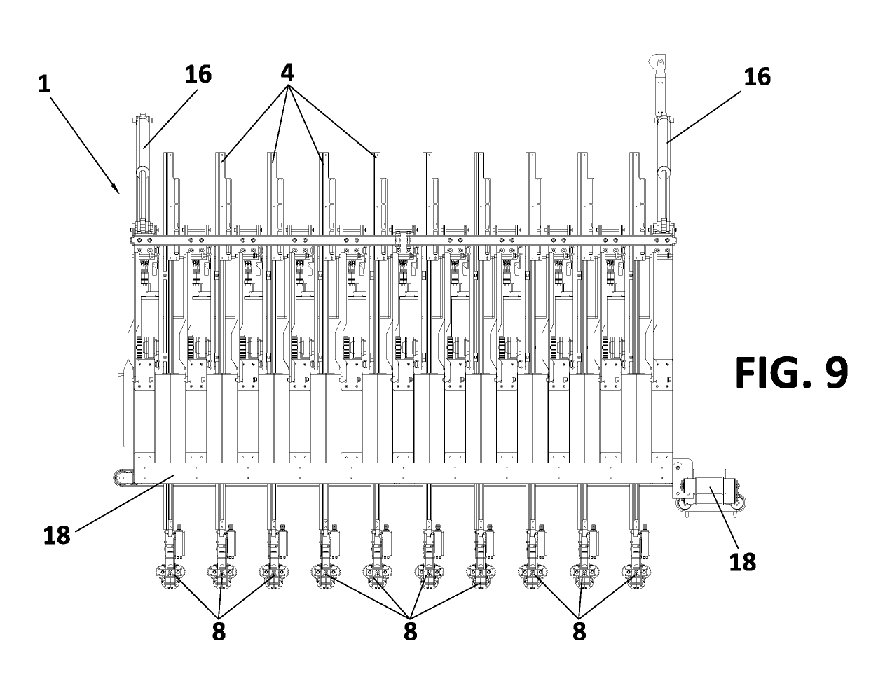

In turn as shown in FIGS. 8 and 9, several pairs of parallel rails (2a, 2b), each one including several fruit cutting and collecting assemblies (5), are arranged consecutively one after the other. Each pair of rails (2a, 2b) is lying within a plane, all the planes are parallel to each other.

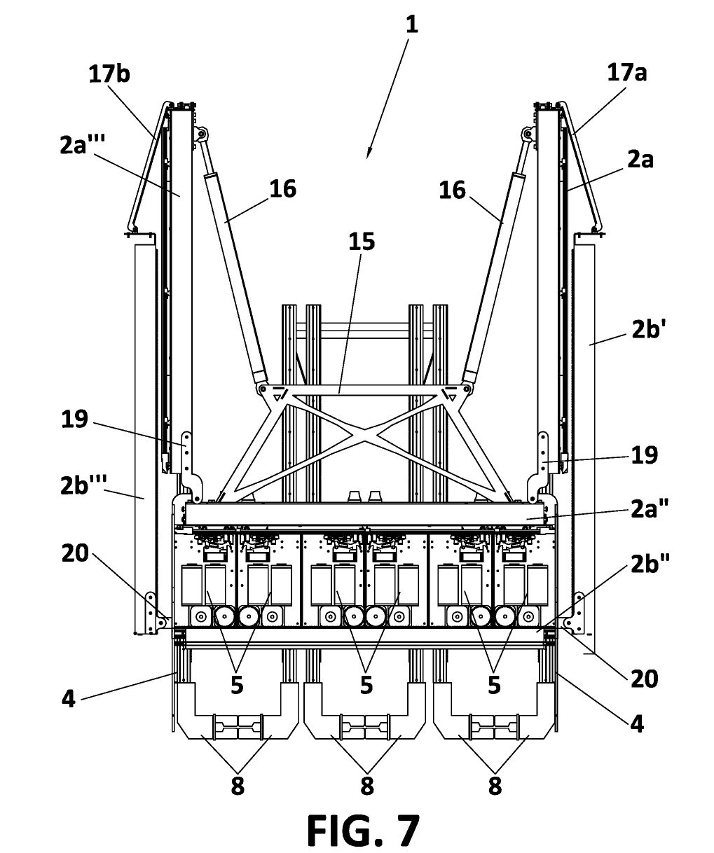

As it can be noted especially in view of FIGS. 8 and 9, due to the compact design of the fruit collecting assembly (5), a large number of robotic arms (4) can be accommodated in the machine, hence the harvesting capacity of the machine is significantly improved. In particular in view of FIG. 8, due to thin profile of the fruit collector assemblies (5), and because each robotic arm (4) only moves in two directions within a plane, the consecutive pairs of rails (2) can the disposed very close to each other. For example in the embodiment shown in FIGS. 7 and 8, sixty robotic arms (4) are accommodated within an area of 9 square meters, which is a remarkable advantage compared with prior art machines which typically requires 4 square meters to allow the movement of a single robotic arm.

The machine (1) includes a self-propelled vehicle (12) having wheels (13), and the pairs of rails (2) and the fruit collecting assemblies (5) are mounted on the vehicle (12), which is adapted to move between crop rows (14) while the robotic arms (4) cut and collect fruits towards conveyor belts (18), by means of which the fruits are transported to a packaging station. Each robotic arm (4) is preferably oriented towards one side of each crop row (14), and operates autonomously and independently from the rest. For example, each robotic arm (4) can be provided with its own viewing system including a camera, and image processing means, so that each robotic arm (4) operates autonomously from the rest.

Conventionally, a viewing system and a control system, are adapted for detecting fruits and for guiding individually the robotic arms towards the fruits. The control system is also adapted to avoid collision between the fruit collecting assemblies (5) mounted in the same pair of rails (2).

The communications between the control system and the fruit collecting assemblies (5), is preferably implemented by Wifi communication, therefore replacement or rearrangement of the robotic arms (4) is very simple.

Another relevant feature of the invention is represented in FIG. 7. Each of the rails (2a, 2b) are formed by several segments articulated to each other, and some segments of the rails can be folded upwardly (within the same plane) in order to reduce the overall volume of the machine and to facilitate transportation and storage.

More in detail in view of FIG. 7, the upper rail (2a) is formed by a central segment (2a″), a first lateral segment (2a′) and a second lateral segment (2a′″), wherein the lateral segments are articulated with respect to the central segment, that is, the lateral segments are joined to the central segment by means of respective pivot points (19). Similarly, the lower rail (2b) is formed by a central segment (2b″), a first lateral segment (2b′) and a second lateral segment (2b′″), wherein the lateral segments are joined to the central segment by means of respective pivot points (20).

Two arms (17a, 17b) are pivotally connected, respectively with the ends of the two lateral segments (2a′, 2b′) and with the ends of the two lateral segments (2a′″, 2b′″), as shown in FIG. 7. Each pair of lateral segment together with its lateral arm, behaves mechanically has a deformable parallelogram.

The machine (1) has at least one framework (15) and two or more actuators, for example hydraulic or pneumatic cylinders (16) connected between the framework (15) and one end, respectively of the lateral segments (2a′, 2a″). When a human operator activates a folded position command for the machine, the control system arrange all the fruit collecting assemblies at the central sections of the rails (2a, 2b), and after that, the cylinders (16) pull the lateral segments of the rails upwards, until the machine is configured in the folded position shown in FIG. 7.

Having sufficiently described the nature of the present invention as well as the manner of putting it into practice, it is not considered necessary to further explain it for any person skilled in the art to understand its scope and the advantages derived therefrom, stating that, within its essential nature, it can be carried out to practice in other embodiments which differ in detail from the one indicated as an example and which are likewise covered by the protection that is sought, provided that its fundamental principle is not altered, changed or modified.

1. Harvesting automatic machine, comprising:
at least a pair of rails parallel to each other,
at least a fruit collector assembly movably coupled with the pair of rails, the fruit collector assembly comprising a carriage movably mounted on the pair of parallel rails, and a robotic arm movably mounted on the carriage, wherein the carriage is movable along the pair of parallel rails, and the robotic arm is movable in a transverse direction to the parallel rails,
a first motor for moving the carriage, and
a second motor for moving the robotic arm,
and wherein the first and second motors are mounted on the carriage.

2. Machine according to claim 1, further comprising two or more fruit collector assemblies movably mounted on the same pair of parallel rails.

3. Machine according to claim 1, further comprising two or more pairs of parallel rails, wherein the pairs of parallel rails are arranged consecutively one after the other in parallel planes.

4. Machine according to claim 1, wherein the rails of the pair of parallel rails has a central segment and at least a first lateral segment articulated with respect to the central segment, and wherein the lateral segment can folded upwardly with respect to the central segment within the same plane.

5. Machine according to claim 1, further comprising a rack and pinion mechanism for moving the carriage, wherein the rack is fitted to one of the rails, and the pinion is engaged with the rack and it associated with the first motor shaft.

6. Machine for according to claim 1, further comprising a rack and pinion mechanism for moving the robotic arm, wherein the rack is fitted to the robotic arm, and the pinion is engaged with the rack and it associated with the second motor shaft.

7. Machine according to claim 1, wherein the rails of the pair of parallel rails include electric conductors, and the first and second motors are electrically connected with said electric conductors to be electrically fed during operation.

8. Machine for according to claim 1, wherein the robotic arm has a cutting and collecting head attached at its lower end for cutting and collecting fruits, wherein the cutting and collecting head has a cutter and a receptacle for collecting a fruit.

9. Machine according to claim 8, further comprising a viewing system and a control system, adapted for detecting fruits and for guiding individually the robotic arms towards the fruits.

10. Machine according to claim 1, further comprising a vehicle and wherein the at least one pair of rails are mounted on the vehicle.

11. Machine according to claim 1, wherein the first and second motors are arranged parallel to each other.

12. Machine according to claim 4, further comprising at least one framework and at least one actuator, connected between the framework and one end of the lateral segment, and wherein the actuator is configured to pull the lateral segment of the rails upwardly.

13. Machine according to claim 12, wherein the control system is adapted to configure the machine in a folded position, and for that, the control system is adapted to arrange all the fruit collector assemblies at the central segment of the associated rails, and after that to move the rail lateral segments by means of the actuator.
